(19) United States
(12) Patent Application Publication
(10) Pub. No.: US 2026/0147602 A1
(43) Pub. Date: May 28, 2026

(54) SYSTEM AND METHOD FOR AUTOMATICALLY LOCKING A VIRTUAL MACHINE TO WRITE DATA ONTO A CACHE MEMORY

(71) Applicant: JPMorgan Chase Bank, N.A., New York, NY (US)

(72) Inventors: Kiran SEKHARAMAHANTHI, Newark, DE (US); Varun MONGA, Bengaluru (IN)

(73) Assignee: JPMorgan Chase Bank, N.A., New York, NY (US)

(21) Appl. No.: 19/010,811

(22) Filed: Jan. 6, 2025

(30) Foreign Application Priority Data
Nov. 22, 2024 (IN) 202411090916

(51) Int. Cl. G06F 9/455

(52) U.S. Cl. CPC G06F 9/45558; G06F 2009/45583

(57) ABSTRACT

Various methods and processes, apparatuses/systems, and media for automatically locking a virtual machine (VM) to write data onto a cache memory when loading data from distributed multi-cloud application environments that include a plurality of VMs, and a loader application are disclosed. A processor assigns a unique identifier (UID) to each VM. Each VM subscribes to the loader application with its corresponding UID; receives, by utilizing the loader application, a ping from each VM for a lock with its UID to write data onto the cache memory within the loader application; determines, by utilizing the loader application, whether any of the VMs is currently locked; randomly selects a first VM in response to determining that none of the VMs are currently locked; and automatically locks the first VM in response to accepting the ping for the lock until writing of data onto the cache memory by the first VM is completed.

### CROSS-REFERENCE TO RELATED APPLICATIONS

This application claims the benefit of priority from Indian Provisional Patent Application No. 202411090916, filed Nov. 22, 2024, which is herein incorporated by reference in its entirety.

### TECHNICAL FIELD

This disclosure generally relates to data processing, and, more particularly, to methods and apparatuses for implementing a platform, language, cloud, and database agnostic automated cache locking module configured for automatically locking a virtual machine to write data onto a cache memory in distributed multi-cloud application environments.

### BACKGROUND

The developments described in this section are known to the inventors. However, unless otherwise indicated, it should not be assumed that any of the developments described in this section qualify as prior art merely by virtue of their inclusion in this section, or that these developments are known to a person of ordinary skill in the art.

With the development of big data technology, many fields use big data technology to process related data, i.e., historical data and real-time data. However, as the business grows and time accumulates, the data volume in the database and cache memories reaches hundreds of millions, and if the data in the database and cache memory is directly processed in batches in real time, the system resources are excessively occupied, so that the data processing efficiency is affected. For example, when data in a database and cache memory is processed in batches, more system resources are required and the processing time is longer because more data needs to be processed; if more system resources are allocated in the data batch processing process, the system resources of the real-time task are occupied, the response speed of the real-time task needing to be responded in real time is affected, and the waiting time of the user is longer.

For example, in transaction utility, a typical processor may handle and store high volume of transactions data. The processor may then expose this data via highly performant and resilient Application Programming Interfaces (APIs) to different channels, such as online application platforms or consumer mobile application platforms. A typical customer related transaction data across these channels may exceed hundreds of millions per day. For example, transaction volumes per day may range from about thousands per retail account to about hundreds of millions per commercial account. APIs use case is to retrieve all transactions for a customer across all his/her accounts for two years to display on Web and Mobile channels when customer logs in. After transaction data is retrieved, it may be enriched with merchant information. These APIs typically have very strict service level agreements (SLAs) of about 50-100 milliseconds (ms) to retrieve the transaction data and need to retrieve at least two years of transaction data and enrich these transactions with merchant data. Moreover, the enrichments may have even more strict SLAs of less than 5 ms. Due to strict SLAs of enrichments they need to be cached and retrieved. The enrichment data is typically procured from external vendors outside of a financial institution and loaded into cache. The feed for these enrichments may be received multiple times in a day.

For example, if there are 10 virtual machines trying to load into one common cache same data, then they will continuously over-write each other's data increasing gossip and network congestion between cache and instances. A conventional approach to avoid race conditions for these kind of issues is by running on single instance or as a batch job as discussed earlier. The problem with this conventional approach is a single point of failure may destroy applications'performance.

Thus, a challenge remains in loading from an external source into multi-cloud application platform cache by real time instances instead of using batch modes. Conventional systems as mentioned above that utilize direct cache access read/write protocols typically implement them in software running on traditional general-purpose processors that function as the main central processing units of the system servers (although multi-threaded implementations that separate processing from transmit/receive functions are common). This arrangement may destroy applications'performance, increase the overhead in terms of processing resources (that could otherwise be used for applications), time (added latency in data transfers), space, and power.

Against this background, it may be desirable for a new technology to further reduce latency, increase scale (wide distribution), increase applications'performance, and reduce the utilization of compute resources (so these computer resources can be freed for devotion to other tasks) in loading data from external distributed multi-cloud application environments.

### SUMMARY

The present disclosure, through one or more of its various aspects, embodiments, and/or specific features or sub-components, provides, among other features, various systems, servers, devices, methods, media, programs, and platforms for implementing a platform, language, cloud, and database agnostic automated cache locking module configured for automatically locking a virtual machine to write data onto a cache memory when loading data from external distributed multi-cloud application environments, thereby reducing data latency, increasing scale (wide distribution of data consumers), and reducing the utilization of compute resources (so these computer resources can be freed for devotion to other tasks), reducing memory consumption, reducing power consumption, increasing applications'performance, etc., but the disclosure is not limited thereto.

In some embodiments, a method for automatically locking a virtual machine to write data onto a cache memory when loading data from distributed multi-cloud application environments that include a plurality of virtual machines and a loader application by utilizing one or more processors along with allocated memory is disclosed. The method may include: assigning a unique identifier to each of the plurality of virtual machines, wherein each of the plurality of virtual machines subscribes to the loader application with its corresponding unique identifier; receiving, by the loader application, a ping from each of the plurality of virtual machines for a lock with its unique identifier to write data onto the cache memory within the loader application; determining, by the loader application, whether any of the plurality of virtual machines is currently locked; randomly selecting a first virtual machine among the plurality of virtual machines in response to determining that none of the plurality of virtual machines are currently locked; and automatically locking the first virtual machine in response to accepting the ping for the lock until writing of data onto the cache memory by the first virtual machine is completed.

In some embodiments, the method may further include: releasing the lock when it is determined that the cache memory is fully loaded upon completion of writing data by the first virtual machine.

In some embodiments, the method may further include: releasing the lock when it is determined that the first virtual machine that has been randomly selected is not writing data onto the cache memory for a configurable predefined period of time; automatically locking a second virtual machine among the plurality of virtual machines in response to accepting corresponding ping for a lock from the second virtual machine until writing of data onto the cache memory by the second virtual machine is completed; and declining pings for additional lock from other virtual machines among the plurality of virtual machines except for the second virtual machine.

In some embodiments, the method may further include: declining pings for additional lock from other virtual machines among the plurality of virtual machines except for the first virtual machine.

In some embodiments, the method may further include: publishing a broadcast, by the loader application to the plurality of virtual machines, identity of the first virtual machine that has acquired the lock via its unique identifier.

In some embodiments, the method may further include: causing each of the plurality of virtual machines to listen to the broadcast; and validating corresponding unique identifier associated with each of the plurality of virtual machines with the unique identifier of the first virtual machine that has acquired the lock.

In some embodiments, the method may further include: determining that there is a match between a corresponding unique identifier associated with a second virtual machine with the unique identifier of the first virtual machine that has acquired the lock; determining that the second virtual machine is the same as the first virtual machine because of the match of the unique identifiers; and allowing the second virtual machine to write data onto the cache memory.

In some embodiments, the method may further include: determining that there is no match between a corresponding unique identifier associated with a second virtual machine with the unique identifier of the first virtual machine that has acquired the lock; determining that the second virtual machine is not the same as the first virtual machine because of mismatch of the unique identifiers; and blocking the second virtual machine to write data onto the cache memory util the lock associated with the first virtual machine is released and until the second virtual machine acquires a lock.

In some embodiments, a system for automatically locking a virtual machine to write data onto a cache memory when loading data from distributed multi-cloud application environments that include a plurality of virtual machines and a loader application is disclosed. The system may include: a processor; and a memory operatively connected to the processor via a communication interface, the memory storing computer readable instructions, when executed, may cause the processor to: assign a unique identifier to each of the plurality of virtual machines, wherein each of the plurality of virtual machines subscribes to the loader application with its corresponding unique identifier; receive, by the loader application, a ping from each of the plurality of virtual machines for a lock with its unique identifier to write data onto the cache memory within the loader application; determine, by the loader application, whether any of the plurality of virtual machines is currently locked; randomly select a first virtual machine among the plurality of virtual machines in response to determining that none of the plurality of virtual machines are currently locked; and automatically lock the first virtual machine in response to accepting the ping for the lock until writing of data onto the cache memory by the first virtual machine is completed.

In some embodiments, the processor may be further configured to: release the lock when it is determined that the cache memory is fully loaded upon completion of writing data by the first virtual machine.

In some embodiments, the processor may be further configured to: release the lock when it is determined that the first virtual machine that has been randomly selected is not writing data onto the cache memory for a configurable predefined period of time; automatically lock a second virtual machine among the plurality of virtual machines in response to accepting corresponding ping for a lock from the second virtual machine until writing of data onto the cache memory by the second virtual machine is completed; and decline pings for additional lock from other virtual machines among the plurality of virtual machines except for the second virtual machine.

In some embodiments, the processor may be further configured to: decline pings for additional lock from other virtual machines among the plurality of virtual machines except for the first virtual machine.

In some embodiments, the processor may be further configured to: publish a broadcast, by the loader application to the plurality of virtual machines, with identity of the first virtual machine that has acquired the lock via its unique identifier.

In some embodiments according to the system, the processor may be further configured to: cause each of the plurality of virtual machines listen to the broadcast; and validate corresponding unique identifier associated with each of the plurality of virtual machines with the unique identifier of the first virtual machine that has acquired the lock.

In some embodiments according to the system, the processor may be further configured to: determine that there is a match between a corresponding unique identifier associated with a second virtual machine with the unique identifier of the first virtual machine that has acquired the lock; determine that the second virtual machine is the same as the first virtual machine because of the match of the unique identifiers; and allow the second virtual machine to write data onto the cache memory.

In some embodiments according to the system, the processor may be further configured to: determine that there is no match between a corresponding unique identifier associated with a second virtual machine with the unique identifier of the first virtual machine that has acquired the lock; determine that the second virtual machine is not the same as the first virtual machine because of mismatch of the unique identifiers; and block the second virtual machine to write data onto the cache memory util the lock associated with the first virtual machine is released and until the second virtual machine acquires a lock.

In some embodiments, a non-transitory computer readable medium configured to store instructions for automatically locking a virtual machine to write data onto a cache memory when loading data from distributed multi-cloud application environments that include a plurality of virtual machines and a loader application is disclosed. The instructions, when executed, may cause a processor to perform the following: assigning a unique identifier to each of the plurality of virtual machines, wherein each of the plurality of virtual machines subscribes to the loader application with its corresponding unique identifier; receiving, by the loader application, a ping from each of the plurality of virtual machines for a lock with its unique identifier to write data onto the cache memory within the loader application; determining, by the loader application, whether any of the plurality of virtual machines is currently locked; randomly selecting a first virtual machine among the plurality of virtual machines in response to determining that none of the plurality of virtual machines are currently locked; and automatically locking the first virtual machine in response to accepting the ping for the lock until writing of data onto the cache memory by the first virtual machine is completed.

In some embodiments, the instructions, when executed, may cause the processor to further perform: releasing the lock when it is determined that the cache memory is fully loaded upon completion of writing data by the first virtual machine.

In some embodiments, the instructions, when executed, may cause the processor to further perform: releasing the lock when it is determined that the first virtual machine that has been randomly selected is not writing data onto the cache memory for a configurable predefined period of time; automatically locking a second virtual machine among the plurality of virtual machines in response to accepting corresponding ping for a lock from the second virtual machine until writing of data onto the cache memory by the second virtual machine is completed; and declining pings for additional lock from other virtual machines among the plurality of virtual machines except for the second virtual machine.

In some embodiments, the instructions, when executed, may cause the processor to further perform: declining pings for additional lock from other virtual machines among the plurality of virtual machines except for the first virtual machine.

In some embodiments, the instructions, when executed, may cause the processor to further perform: publishing a broadcast, by the loader application to the plurality of virtual machines, identity of the first virtual machine that has acquired the lock via its unique identifier.

In some embodiments, the instructions, when executed, may cause the processor to further perform: causing each of the plurality of virtual machines to listen to the broadcast; and validating corresponding unique identifier associated with each of the plurality of virtual machines with the unique identifier of the first virtual machine that has acquired the lock.

In some embodiments, the instructions, when executed, may cause the processor to further perform: determining that there is a match between a corresponding unique identifier associated with a second virtual machine with the unique identifier of the first virtual machine that has acquired the lock; determining that the second virtual machine is the same as the first virtual machine because of the match of the unique identifiers; and allowing the second virtual machine to write data onto the cache memory.

In some embodiments, the instructions, when executed, may cause the processor to further perform: determining that there is no match between a corresponding unique identifier associated with a second virtual machine with the unique identifier of the first virtual machine that has acquired the lock; determining that the second virtual machine is not the same as the first virtual machine because of mismatch of the unique identifiers; and blocking the second virtual machine to write data onto the cache memory util the lock associated with the first virtual machine is released and until the second virtual machine acquires a lock.

### BRIEF DESCRIPTION OF THE DRAWINGS

The present disclosure is further described in the detailed description which follows, in reference to the noted plurality of drawings, by way of non-limiting examples of preferred embodiments of the present disclosure, in which like characters represent like elements throughout the several views of the drawings.

FIG. 1 illustrates a computer system for implementing a platform, language, database, and cloud agnostic automated cache locking module configured to automatically lock a virtual machine to write data onto a cache memory when loading data from external distributed multi-cloud application environments in accordance with an embodiment.

FIG. 2 illustrates a diagram of a network environment with a platform, language, database, and cloud agnostic automated cache locking device in accordance with an embodiment.

FIG. 3 illustrates a system diagram for implementing a platform, language, database, and cloud agnostic automated cache locking device having a platform, language, database, and cloud agnostic automated cache locking module in accordance with an embodiment.

FIG. 4 illustrates a system diagram for implementing a platform, language, database, and cloud agnostic automated cache locking module of FIG. 3 in accordance with an embodiment.

FIG. 5A illustrates an architecture implemented by the platform, language, database, and cloud agnostic automated cache locking module of FIG. 4 for receiving ping from a plurality of virtual machines to obtain a lock in accordance with an embodiment.

FIG. 5B illustrates an architecture implemented by the platform, language, database, and cloud agnostic automated cache locking module of FIG. 4 for broadcasting to the plurality of virtual machines that a lock has been acquired for one of the plurality of virtual machines which requested a lock in FIG. 5A in accordance with an embodiment.

FIG. 5C illustrates an architecture implemented by the platform, language, database, and cloud agnostic automated cache locking module of FIG. 4 where the virtual machine which obtained the lock in FIG. 5B is allowed to write onto the cache memory and the remaining virtual machines go to a sleeping mode in accordance with an embodiment.

FIG. 6 illustrates a flow chart of a process implemented by the platform, language, database, and cloud agnostic automated cache locking module of FIG. 4 for automatically locking a virtual machine to write data onto a cache memory when loading data from external distributed multi-cloud application environments in accordance with an embodiment.

### DETAILED DESCRIPTION

Through one or more of its various aspects, embodiments and/or specific features or sub-components of the present disclosure, are intended to bring out one or more of the advantages as specifically described above and noted below.

The examples may also be embodied as one or more non-transitory computer readable media having instructions stored thereon for one or more aspects of the present technology as described and illustrated by way of the examples herein. The instructions in may include executable code that, when executed by one or more processors, cause the processors to carry out steps necessary to implement the methods of the examples of this technology that are described and illustrated herein.

As is traditional in the field of the present disclosure, example embodiments are described, and illustrated in the drawings, in terms of functional blocks, units and/or modules. Those skilled in the art will appreciate that these blocks, units and/or modules are physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies. In the case of the blocks, units and/or modules being implemented by microprocessors or similar, they may be programmed using software (e.g., microcode) to perform various functions discussed herein and may optionally be driven by firmware and/or software. Alternatively, each block, unit and/or module may be implemented by dedicated hardware, or as a combination of dedicated hardware to perform some functions and a processor (e.g., one or more programmed microprocessors and associated circuitry) to perform other functions. Also, each block, unit and/or module of the example embodiments may be physically separated into two or more interacting and discrete blocks, units and/or modules without departing from the scope of the inventive concepts. Further, the blocks, units and/or modules of the example embodiments may be physically combined into more complex blocks, units and/or modules without departing from the scope of the present disclosure.

As mentioned earlier, with the development of big data technology, many fields use big data technology to process related data, i.e., historical transaction data and real-time transaction data. However, as the business grows and time accumulates, the data volume in the database and cache memories reaches hundreds of millions, and if the data in the database and cache memory is directly processed in batches in real time, the system resources are excessively occupied, so that the data processing efficiency is affected. For example, when data in a database and cache memory is processed in batches, more system resources are required and the processing time is longer because more data needs to be processed; if more system resources are allocated in the data batch processing process, the system resources of the real-time task are occupied, the response speed of the real-time task needing to be responded in real time is affected, and the waiting time of the user is longer.

Moreover, distributing large volumes of data may prove to be a key challenge for computing and information systems of any appreciable scale. The embodiments disclosed herein may apply to a vast spectrum of applications that would benefit from low-latency delivery of large volumes of data to multiple data consumers. These embodiments fundamentally address the practical problems of distributing such data over bandwidth-limited communication channels to compute-limited data consumers. This problem may be particularly acute in connection with real-time data. Real-time data distribution systems must contend with these physical limits when the real-time data rates exceed the ability of the communication channel to transfer the data and/or the ability of the data consumers to consume the data.

For example, as mentioned earlier, in transaction utility, a typical processor may handle and store high volume of transactions data. The processor may then expose this data via highly performant and resilient APIs to different channels, such as online application platforms or consumer mobile application platforms. A typical customer related transaction data across these channels may exceed hundreds of millions per day. For example, transaction volumes per day may range from about thousands per retail account to about hundreds of millions per commercial account. APIs use case is to retrieve all transactions for a customer across all his/her accounts for two years to display on Web and Mobile channels when customer logs in. After transaction data is retrieved, it may be enriched with merchant information. These APIs typically have very strict SLAs of about 50-100 milliseconds (ms) to retrieve the transaction data and need to retrieve at least two years of transaction data and enrich these transactions with merchant data. Moreover, the enrichments may have even more strict SLAs of less than 5 ms. Due to strict SLAs of enrichments they need to be cached and retrieved. The enrichment data is typically procured from external vendors outside of a financial institution and loaded into cache. The feed for these enrichments may be received multiple times in a day.

However, a challenge remains in loading from an external source into multi-cloud application platform cache by real time instances instead of using batch modes. Conventional systems that utilize direct cache access read protocols typically implement them in software running on traditional general-purpose processors that function as the main central processing units of the system servers (although multi-threaded implementations that separate processing from transmit/receive functions are common). This arrangement may increase the overhead in terms of processing resources (that could otherwise be used for applications), time (added latency in data transfers), space, and power.

The present disclosure, through one or more of its various aspects, embodiments, and/or specific features or sub-components, provides, among other features, various systems, servers, devices, methods, media, programs, and platforms for implementing a platform, language, cloud, and database agnostic automated cache locking module configured for automatically locking a cache memory when loading data from external distributed multi-cloud application environments, thereby reducing data latency, increasing scale (wide distribution of data consumers), and reducing the utilization of compute resources (so these computer resources can be freed for devotion to other tasks), reducing memory consumption, reducing power consumption, etc., but the disclosure is not limited thereto.

Although the processes as disclosed herein utilized transaction data, the processes as disclosed herein may be utilized in other use cases, such as medical records data, student records data, employee records data, etc., but the disclosure is not limited thereto.

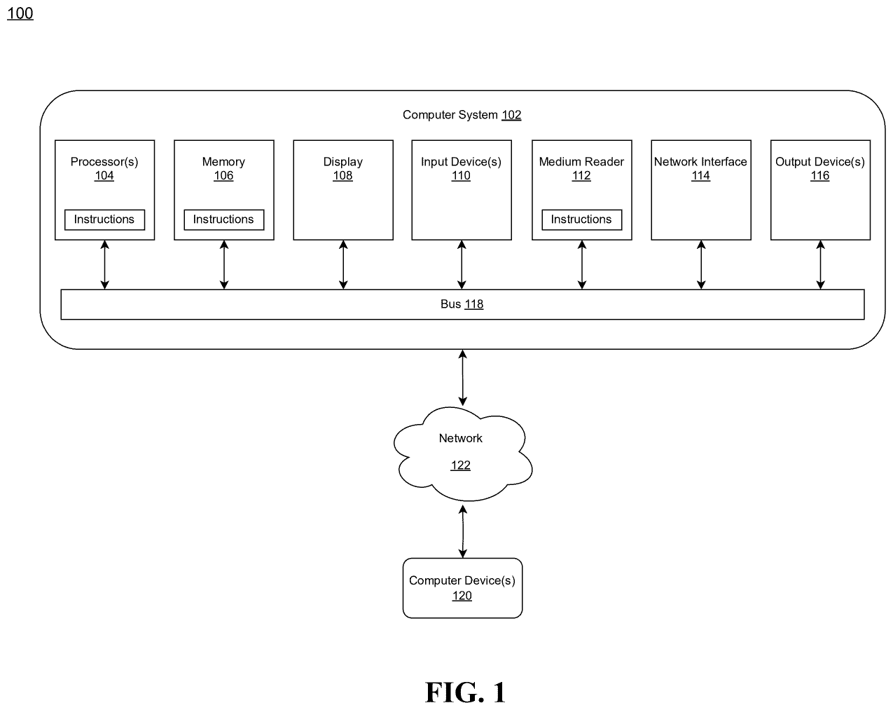

FIG. 1 is an exemplary system 100 for use in implementing a platform, language, database, and cloud agnostic automated cache locking module configured for automatically locking a virtual machine to write data onto a cache memory when loading data from external distributed multi-cloud application environments in accordance with an exemplary embodiment. The system 100 is generally shown and may include a computer system 102, which is generally indicated.

The computer system 102 may include a set of instructions that may be executed to cause the computer system 102 to perform any one or more of the methods or computer-based functions disclosed herein, either alone or in combination with the other described devices. The computer system 102 may operate as a standalone device or may be connected to other systems or peripheral devices. In some embodiments, the computer system 102 may include, or be included within, any one or more computers, servers, systems, communication networks or cloud environment. Even further, the instructions may be operative in such cloud-based computing environment.

In a networked deployment, the computer system 102 may operate in the capacity of a server or as a client user computer in a server-client user network environment, a client user computer in a cloud computing environment, or as a peer computer system in a peer-to-peer (or distributed) network environment. The computer system 102, or portions thereof, may be implemented as, or incorporated into, various devices, such as a personal computer, a tablet computer, a set-top box, a personal digital assistant, a mobile device, a palmtop computer, a laptop computer, a desktop computer, a communications device, a wireless smart phone, a personal trusted device, a wearable device, a global positioning satellite (GPS) device, a web appliance, or any other machine capable of executing a set of instructions (sequential or otherwise) that specify actions to be taken by that machine. Further, while a single computer system 102 is illustrated, additional embodiments may include any collection of systems or sub-systems that individually or jointly execute instructions or perform functions. The term system shall be taken throughout the present disclosure to include any collection of systems or sub-systems that individually or jointly execute a set, or multiple sets, of instructions to perform one or more computer functions.

As illustrated in FIG. 1, the computer system 102 may include at least one processor 104. The processor 104 may be tangible and non-transitory. As used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The processor 104 may be an article of manufacture and/or a machine component. The processor 104 may be configured to execute software instructions in order to perform functions as described in the various embodiments herein. The processor 104 may be a general-purpose processor or may be part of an application specific integrated circuit (ASIC). The processor 104 may also be a microprocessor, a microcomputer, a processor chip, a controller, a microcontroller, a digital signal processor (DSP), a state machine, or a programmable logic device. The processor 104 may also be a logical circuit, including a programmable gate array (PGA) such as a field programmable gate array (FPGA), or another type of circuit that includes discrete gate and/or transistor logic. The processor 104 may be a central processing unit (CPU), a graphics processing unit (GPU), or both. Additionally, any processor described herein may include multiple processors, parallel processors, or both. Multiple processors may be included in, or coupled to, a single device or multiple devices.

The computer system 102 may also include a computer memory 106. The computer memory 106 may include a static memory, a dynamic memory, or both in communication. Memories described herein are tangible storage mediums that may store data and executable instructions, and are non-transitory during the time instructions are stored therein. Again, as used herein, the term “non-transitory” is to be interpreted not as an eternal characteristic of a state, but as a characteristic of a state that will last for a period of time. The term “non-transitory” specifically disavows fleeting characteristics such as characteristics of a particular carrier wave or signal or other forms that exist only transitorily in any place at any time. The memories are an article of manufacture and/or machine component. Memories described herein are computer-readable mediums from which data and executable instructions may be read by a computer. Memories as described herein may be random access memory (RAM), read only memory (ROM), flash memory, electrically programmable read only memory (EPROM), electrically erasable programmable read-only memory (EEPROM), registers, a hard disk, a cache, a removable disk, tape, compact disk read only memory (CD-ROM), digital versatile disk (DVD), floppy disk, or any other form of storage medium known in the art. Memories may be volatile or non-volatile, secure and/or encrypted, unsecure and/or unencrypted. Of course, the computer memory 106 may comprise any combination of memories or a single storage.

The computer system 102 may further include a display 108, such as a liquid crystal display (LCD), an organic light emitting diode (OLED), a flat panel display, a solid-state display, a cathode ray tube (CRT), a plasma display, or any other known display.

The computer system 102 may also include at least one input device 110, such as a keyboard, a touch-sensitive input screen or pad, a speech input, a mouse, a remote control device having a wireless keypad, a microphone coupled to a speech recognition engine, a camera such as a video camera or still camera, a cursor control device, a global positioning system (GPS) device, a visual positioning system (VPS) device, an altimeter, a gyroscope, an accelerometer, a proximity sensor, or any combination thereof. Those skilled in the art appreciate that various embodiments of the computer system 102 may include multiple input devices 110. Moreover, those skilled in the art further appreciate that the above-listed, exemplary input devices 110 are not meant to be exhaustive and that the computer system 102 may include any additional, or alternative, input devices 110.

The computer system 102 may also include a medium reader 112 which may be configured to read any one or more sets of instructions, e.g., software, from any of the memories described herein. The instructions, when executed by a processor, may be used to perform one or more of the methods and processes as described herein. In a particular embodiment, the instructions may reside completely, or at least partially, within the memory 106, the medium reader 112, and/or the processor 104 during execution by the computer system 102.

Furthermore, the computer system 102 may include any additional devices, components, parts, peripherals, hardware, software or any combination thereof which are commonly known and understood as being included with or within a computer system, such as, but not limited to, a network interface 114 and an output device 116. The output device 116 may be, but is not limited to, a speaker, an audio out, a video out, a remote control output, a printer, or any combination thereof.

Each of the components of the computer system 102 may be interconnected and communicate via a bus 118 or other communication link. As shown in FIG. 1, the components may each be interconnected and communicate via an internal bus. However, those skilled in the art appreciate that any of the components may also be connected via an expansion bus. Moreover, the bus 118 may enable communication via any standard or other specification commonly known and understood such as, but not limited to, peripheral component interconnect, peripheral component interconnect express, parallel advanced technology attachment, serial advanced technology attachment, etc.

The computer system 102 may be in communication with one or more additional computer devices 120 via a network 122. The network 122 may be, but is not limited to, a local area network, a wide area network, the Internet, a telephony network, a short-range network, or any other network commonly known and understood in the art. The short-range network may include, in some embodiments, infrared, near field communication, ultraband, or any combination thereof. Those skilled in the art appreciate that additional networks 122 which are known and understood may additionally or alternatively be used and that the exemplary networks 122 are not limiting or exhaustive. Also, while the network 122 is shown in FIG. 1 as a wireless network, those skilled in the art appreciate that the network 122 may also be a wired network.

The additional computer device 120 is shown in FIG. 1 as a personal computer. However, those skilled in the art appreciate that, in alternative embodiments of the present application, the computer device 120 may be a laptop computer, a tablet PC, a personal digital assistant, a mobile device, a palmtop computer, a desktop computer, a communications device, a wireless telephone, a personal trusted device, a web appliance, a server, or any other device that may be capable of executing a set of instructions, sequential or otherwise, that specify actions to be taken by that device. Of course, those skilled in the art appreciate that the above-listed devices are merely exemplary devices and that the device 120 may be any additional device or apparatus commonly known and understood in the art without departing from the scope of the present application. In some embodiments, the computer device 120 may be the same or similar to the computer system 102. Furthermore, those skilled in the art similarly understand that the device may be any combination of devices and apparatuses.

Of course, those skilled in the art appreciate that the above-listed components of the computer system 102 are merely meant to be exemplary and are not intended to be exhaustive and/or inclusive. Furthermore, the examples of the components listed above are also meant to be exemplary and similarly are not meant to be exhaustive and/or inclusive.

In some embodiments, the automated cache locking module may be platform, language, database, and cloud agnostic that may allow for consistent easy orchestration and passing of data through various components to output a desired result regardless of platform, browser, language, database, and cloud environment. Since the disclosed process, in some embodiments, may be platform, language, database, browser, and cloud agnostic, the automated cache locking module may be independently tuned or modified for optimal performance without affecting the configuration or data files. The configuration or data files, in some embodiments, may be written using JSON, but the disclosure is not limited thereto. In some embodiments, the configuration or data files may easily be extended to other readable file formats such as XML, YAML, etc., or any other configuration based languages.

In accordance with various embodiments of the present disclosure, the methods described herein may be implemented using a hardware computer system that executes software programs. Further, in an exemplary, non-limited embodiment, implementations may include distributed processing, component/object distributed processing, and an operation mode having parallel processing capabilities. Virtual computer system processing may be constructed to implement one or more of the methods or functionality as described herein, and a processor described herein may be used to support a virtual processing environment.

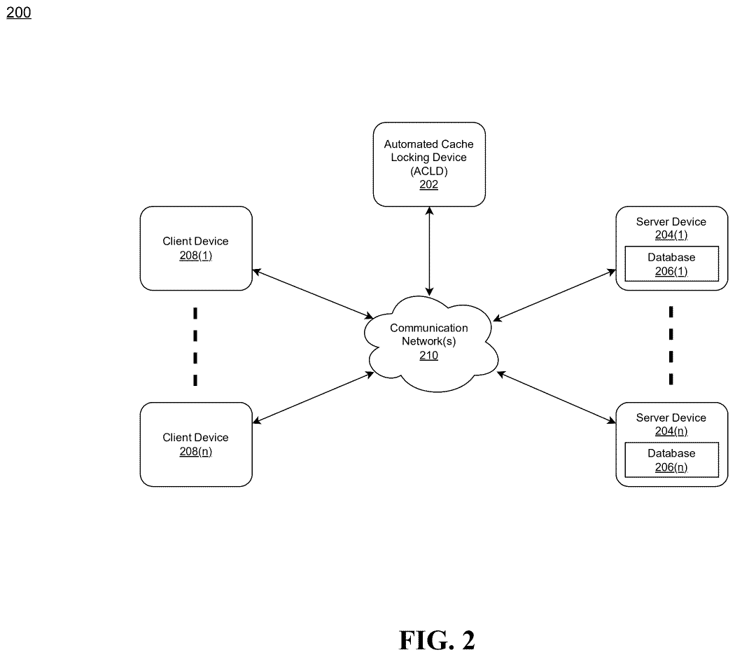

Referring to FIG. 2, a schematic of an exemplary network environment 200 for implementing a language, platform, database, and cloud agnostic automated cache locking device (ACLD) of the instant disclosure is illustrated.

In some embodiments, the above-described problems associated with conventional tools may be overcome by implementing an ACLD 202 as illustrated in FIG. 2 that may be configured for implementing a platform, language, database, and cloud agnostic automated cache locking module configured for automatically locking a virtual machine to write data onto a cache memory when loading data from external distributed multi-cloud application environments, thereby reducing data latency, increasing scale (wide distribution of data consumers), and reducing the utilization of compute resources (so these computer resources can be freed for devotion to other tasks), reducing memory consumption, reducing power consumption, etc., but the disclosure is not limited thereto.

The ACLD 202 may have one or more computer system 102s, as described with respect to FIG. 1, which in aggregate provide the necessary functions.

The ACLD 202 may store one or more applications that may include executable instructions that, when executed by the ACLD 202, cause the ACLD 202 to perform actions, such as to transmit, receive, or otherwise process network messages, in some embodiments, and to perform other actions described and illustrated below with reference to the figures. The application(s) may be implemented as modules or components of other applications. Further, the application(s) may be implemented as operating system extensions, modules, plugins, or the like.

Even further, the application(s) may be operative in a cloud-based computing environment. The application(s) may be executed within or as virtual machine(s) or virtual server(s) that may be managed in a cloud-based computing environment. Also, the application(s), and even the ACLD 202 itself, may be located in virtual server(s) running in a cloud-based computing environment rather than being tied to one or more specific physical network computing devices. Also, the application(s) may be running in one or more virtual machines (VMs) executing on the ACLD 202. Additionally, in one or more embodiments of this technology, virtual machine(s) running on the ACLD 202 may be managed or supervised by a hypervisor.

In the network environment 200 of FIG. 2, the ACLD 202 may be coupled to a plurality of server devices 204(1)-204(n) that hosts a plurality of databases 206(1)-206(n), and also to a plurality of client devices 208(1)-208(n) via communication network(s) 210. A communication interface of the ACLD 202, such as the network interface 114 of the computer system 102 of FIG. 1, operatively couples and communicates between the ACLD 202, the server devices 204(1)-204(n), and/or the client devices 208(1)-208(n), which may all be coupled together by the communication network(s) 210, although other types and/or numbers of communication networks or systems with other types and/or numbers of connections and/or configurations to other devices and/or elements may also be used.

The communication network(s) 210 may be the same or similar to the network 122 as described with respect to FIG. 1, although the ACLD 202, the server devices 204(1)-204(n), and/or the client devices 208(1)-208(n) may be coupled together via other topologies. Additionally, the network environment 200 may include other network devices such as one or more routers and/or switches, in some embodiments, which are well known in the art and thus will not be described herein.

By way of example only, the communication network(s) 210 may include local area network(s) (LAN(s)) or wide area network(s) (WAN(s)), and may use TCP/IP over Ethernet and industry-standard protocols, although other types and/or numbers of protocols and/or communication networks may be used. The communication network(s) 210 in this example may employ any suitable interface mechanisms and network communication technologies including, in some embodiments, teletraffic in any suitable form (e.g., voice, modem, and the like), Public Switched Telephone Network (PSTNs), Ethernet-based Packet Data Networks (PDNs), combinations thereof, and the like.

The ACLD 202 may be a standalone device or integrated with one or more other devices or apparatuses, such as one or more of the server devices 204(1)-204(n). In some embodiments, the ACLD 202 may be hosted by one of the server devices 204(1)-204(n), and other arrangements may also be possible. Moreover, one or more of the devices of the ACLD 202 may be in the same or a different communication network including one or more public, private, or cloud networks, in some embodiments.

The plurality of server devices 204(1)-204(n) may be the same or similar to the computer system 102 or the computer device 120 as described with respect to FIG. 1, including any features or combination of features described with respect thereto. In some embodiments, any of the server devices 204(1)-204(n) may include, among other features, one or more processors, a memory, and a communication interface, which may be coupled together by a bus or other communication link, although other numbers and/or types of network devices may be used. The server devices 204(1)-204(n) in this example may process requests received from the ACLD 202 via the communication network(s) 210 according to the HTTP-based and/or JavaScript Object Notation (JSON) protocol, in some embodiments, although other protocols may also be used.

The server devices 204(1)-204(n) may be hardware or software or may represent a system with multiple servers in a pool, which may include internal or external networks. The server devices 204(1)-204(n) hosts the databases 206(1)-206(n) that may be configured to store metadata sets, data quality rules, and newly generated data.

Although the server devices 204(1)-204(n) are illustrated as single devices, one or more actions of each of the server devices 204(1)-204(n) may be distributed across one or more distinct network computing devices that together comprise one or more of the server devices 204(1)-204(n). Moreover, the server devices 204(1)-204(n) are not limited to a particular configuration. Thus, the server devices 204(1)-204(n) may contain a plurality of network computing devices that operate using a master/slave approach, whereby one of the network computing devices of the server devices 204(1)-204(n) operates to manage and/or otherwise coordinate operations of the other network computing devices.

In some embodiments, the server devices 204(1)-204(n) may operate as a plurality of network computing devices within a cluster architecture, a peer-to peer architecture, virtual machines, or within a cloud architecture. Thus, the technology disclosed herein is not to be construed as being limited to a single environment and other configurations and architectures may also be envisaged.

The plurality of client devices 208(1)-208(n) may also be the same or similar to the computer system 102 or the computer device 120 as described with respect to FIG. 1, including any features or combination of features described with respect thereto. Client device in this context refers to any computing device that interfaces to communications network(s) 210 to obtain resources from one or more server devices 204(1)-204(n) or other client devices 208(1)-208(n).

In some embodiments, the client devices 208(1)-208(n) in this example may include any type of computing device that may facilitate the implementation of the ACLD 202 that may efficiently provide a platform for implementing a platform, language, database, and cloud agnostic automated cache locking module configured for automatically locking a virtual machine to write data onto a cache memory when loading data from external distributed multi-cloud application environments, thereby reducing data latency, increasing scale (wide distribution of data consumers), and reducing the utilization of compute resources (so these computer resources can be freed for devotion to other tasks), reducing memory consumption, reducing power consumption, etc., but the disclosure is not limited thereto.

The client devices 208(1)-208(n) may run interface applications, such as standard web browsers or standalone client applications, which may provide an interface to communicate with the ACLD 202 via the communication network(s) 210 in order to communicate user requests. The client devices 208(1)-208(n) may further include, among other features, a display device, such as a display screen or touchscreen, and/or an input device, such as a keyboard, in some embodiments.

Although the exemplary network environment 200 with the ACLD 202, the server devices 204(1)-204(n), the client devices 208(1)-208(n), and the communication network(s) 210 are described and illustrated herein, other types and/or numbers of systems, devices, components, and/or elements in other topologies may be used. It is to be understood that the systems of the examples described herein are for exemplary purposes, as many variations of the specific hardware and software used to implement the examples are possible, as may be appreciated by those skilled in the relevant art(s).

One or more of the devices depicted in the network environment 200, such as the ACLD 202, the server devices 204(1)-204(n), or the client devices 208(1)-208(n), in some embodiments, may be configured to operate as virtual instances on the same physical machine. In some embodiments, one or more of the ACLD 202, the server devices 204(1)-204(n), or the client devices 208(1)-208(n) may operate on the same physical device rather than as separate devices communicating through communication network(s) 210. Additionally, there may be more or fewer ACLDs 202, server devices 204(1)-204(n), or client devices 208(1)-208(n) than illustrated in FIG. 2. In some embodiments, the ACLD 202 may be configured to send code at run-time to remote server devices 204(1)-204(n), but the disclosure is not limited thereto.

In addition, two or more computing systems or devices may be substituted for any one of the systems or devices in any example. Accordingly, principles and advantages of distributed processing, such as redundancy and replication also may be implemented, as desired, to increase the robustness and performance of the devices and systems of the examples. The examples may also be implemented on computer system(s) that extend across any suitable network using any suitable interface mechanisms and traffic technologies, including by way of example only teletraffic in any suitable form (e.g., voice and modem), wireless traffic networks, cellular traffic networks, Packet Data Networks (PDNs), the Internet, intranets, and combinations thereof.

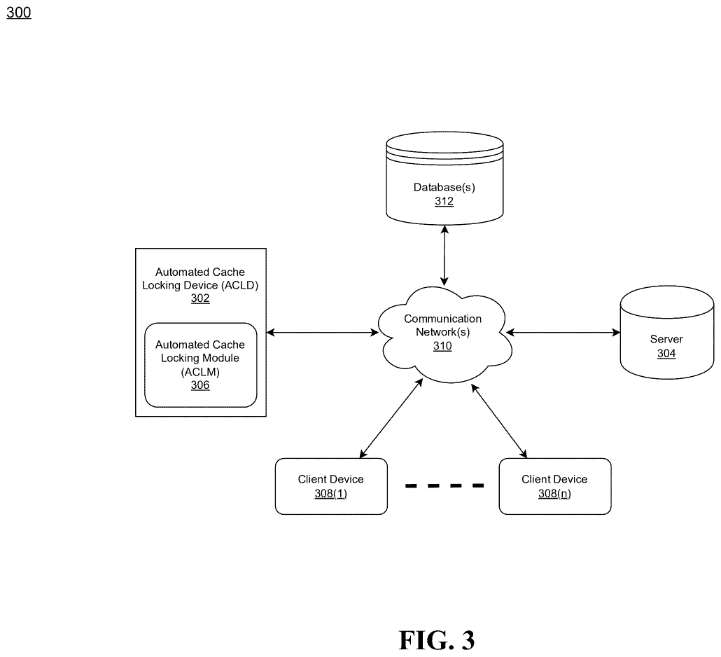

FIG. 3 illustrates a system diagram for implementing a platform, language, and cloud agnostic ACLD having a platform, language, database, and cloud agnostic automated cache locking module (ACLM) in accordance with an embodiment.

As illustrated in FIG. 3, the system 300 may include an ACLD 302 within which an ACLM 306 may be embedded, a server 304, a database(s) 312, a plurality of client devices 308(1) . . . 308(n), and a communication network 310.

In some embodiments, the ACLD 302 including the ACLM 306 may be connected to the server 304, and the database(s) 312 via the communication network 310. The ACLD 302 may also be connected to the plurality of client devices 308(1) . . . 308(n) via the communication network 310, but the disclosure is not limited thereto.

According to exemplary embodiment, the ACLD 302 is described and shown in FIG. 3 as including the ACLM 306, although it may include other rules, policies, modules, databases, or applications, etc. In some embodiments, the database(s) 312 may be configured to store ready to use modules written for each API for all environments. Although only one database is illustrated in FIG. 3, the disclosure is not limited thereto. Any number of desired databases may be utilized for use in the disclosed invention herein. The database(s) 312 may be a mainframe database, a log database that may produce programming for searching, monitoring, and analyzing machine-generated data via a web interface, etc., but the disclosure is not limited thereto.

In some embodiments, the ACLM 306 may be configured to receive real-time feed of data from the plurality of client devices 308(1) . . . 308(n) and secondary sources via the communication network 310.

As may be described below, the ACLM 306 may be configured to: assign a unique identifier to each of the plurality of virtual machines, wherein each of the plurality of virtual machines subscribes to the loader application with its corresponding unique identifier; receive, by the loader application, a ping from each of the plurality of virtual machines for a lock with its unique identifier to write data onto the cache memory within the loader application; determine, by the loader application, whether any of the plurality of virtual machines is currently locked; randomly select a first virtual machine among the plurality of virtual machines in response to determining that none of the plurality of virtual machines are currently locked; and automatically lock the first virtual machine in response to accepting the ping for the lock until writing of data onto the cache memory by the first virtual machine is completed, thereby reducing data latency, increasing scale (wide distribution of data consumers), and reducing the utilization of compute resources (so these computer resources can be freed for devotion to other tasks), reducing memory consumption, reducing power consumption, etc., but the disclosure is not limited thereto.

The plurality of client devices 308(1) . . . 308(n) are illustrated as being in communication with the ACLD 302. In this regard, the plurality of client devices 308(1) . . . 308(n) may be “clients” (e.g., customers) of the ACLD 302 and are described herein as such. Nevertheless, it is to be known and understood that the plurality of client devices 308(1) . . . 308(n) need not necessarily be “clients” of the ACLD 302, or any entity described in association therewith herein. Any additional or alternative relationship may exist between either or both of the plurality of client devices 308(1) . . . 308(n) and the ACLD 302, or no relationship may exist.

The first client device 308(1) may be, in some embodiments, a smart phone. Of course, the first client device 308(1) may be any additional device described herein. The second client device 308(n) may be, in some embodiments, a personal computer (PC). Of course, the second client device 308(n) may also be any additional device described herein. In some embodiments, the server 304 may be the same or equivalent to the server device 204 as illustrated in FIG. 2.

The process may be executed via the communication network 310, which may comprise plural networks as described above. In an embodiment, one or more of the plurality of client devices 308(1) . . . 308(n) may communicate with the ACLD 302 via broadband or cellular communication. Of course, these embodiments are merely exemplary and are not limiting or exhaustive.

The computing device 301 may be the same or similar to any one of the client devices 208(1)-208(n) as described with respect to FIG. 2, including any features or combination of features described with respect thereto. The ACLD 302 may be the same or similar to the ACLD 202 as described with respect to FIG. 2, including any features or combination of features described with respect thereto.

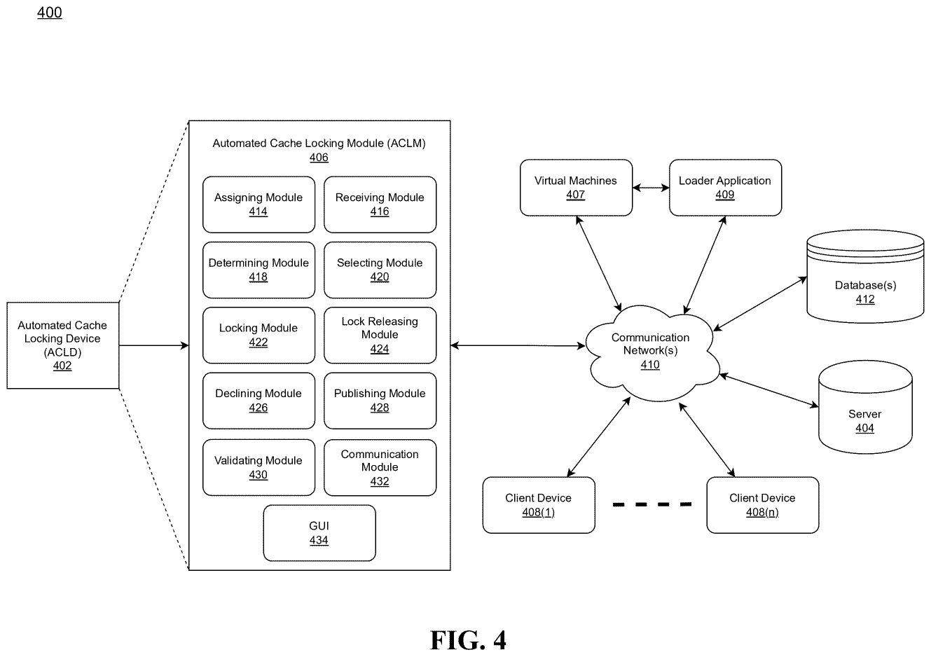

FIG. 4 illustrates a system diagram for implementing a platform, language, database, and cloud agnostic ACLM of FIG. 3 in accordance with an exemplary embodiment.

In some embodiments, the system 400 may include a platform, language, database, and cloud agnostic ACLD 402 within which a platform, language, database, and cloud agnostic ACLM 406 may be embedded, a server 404, a plurality of virtual machines 407(1)-407(n), a loader application 409, database(s) 412, and a communication network 410. In some embodiments, server 404 may comprise a plurality of servers located centrally or located in different locations, but the disclosure is not limited thereto.

In some embodiments, the ACLD 402 including the ACLM 406 may be connected to the server 404, the plurality of virtual machines 407(1)-407(n), the loader application 409, and the database(s) 412 via the communication network 410 thereby creating distributed multi-cloud application environments. The ACLD 402 may also be connected to the plurality of client devices 408(1)-408(n) via the communication network 410, but the disclosure is not limited thereto. The ACLM 406, the server 404, the plurality of client devices 408(1)-408(n), the database(s) 412, the communication network 410 as illustrated in FIG. 4 may be the same or similar to the ACLM 306, the server 304, the plurality of client devices 308(1)-308(n), the database(s) 312, the communication network 310, respectively, as illustrated in FIG. 3.

In some embodiments, as illustrated in FIG. 4, the ACLM 406 may include an assigning module 414, a receiving module 416, a determining module 418, a selecting module 420, a locking module 422, a lock releasing module 424, a declining module 426, a publishing module 428, a validating module 430, a communication module 432, and a Graphical User Interface (GUI) 434. In some embodiments, interactions and data exchange among these modules included in the ACLM 406 provide the advantageous effects of the disclosed invention. Functionalities of each module of FIG. 4 may be described in detail below with reference to FIGS. 4-8.

In some embodiments, each of the assigning module 414, receiving module 416, determining module 418, selecting module 420, locking module 422, lock releasing module 424, declining module 426, publishing module 428, validating module 430, and the communication module 432 of the ACLM 406 of FIG. 4 may be physically implemented by electronic (or optical) circuits such as logic circuits, discrete components, microprocessors, hard-wired circuits, memory elements, wiring connections, and the like, which may be formed using semiconductor-based fabrication techniques or other manufacturing technologies.

In some embodiments, each of the assigning module 414, receiving module 416, determining module 418, selecting module 420, locking module 422, lock releasing module 424, declining module 426, publishing module 428, validating module 430, and the communication module 432 of the ACLM 406 of FIG. 4 may be implemented by microprocessors or similar, and may be programmed using software (e.g., microcode) to perform various functions discussed herein and may optionally be driven by firmware and/or software.

Alternatively, in some embodiments, each of the assigning module 414, receiving module 416, determining module 418, selecting module 420, locking module 422, lock releasing module 424, declining module 426, publishing module 428, validating module 430, and the communication module 432 of the ACLM 406 of FIG. 4 may be implemented by dedicated hardware, or as a combination of dedicated hardware to perform some functions and a processor (e.g., one or more programmed microprocessors and associated circuitry) to perform other functions, but the disclosure is not limited thereto. In some embodiments, the ACLM 406 of FIG. 4 may also be implemented by cloud-based deployment.

In some embodiments, each of the assigning module 414, receiving module 416, determining module 418, selecting module 420, locking module 422, lock releasing module 424, declining module 426, publishing module 428, validating module 430, and the communication module 432 of the ACLM 406 of FIG. 4 may be called via corresponding API, but the disclosure is not limited thereto. For example, in some embodiments, the assigning module 414 may be called via a first API, the receiving module 416 may be called via a second API, the determining module 418 may be called via a third API, the selecting module 420 may be called via a fourth API, the locking module 422 may be called via a fifth API, the lock releasing module 424 may be called via a sixth API, the declining module 426 may be called via a seventh API, the publishing module 428 may be called via an eight API, the validating module 430 may be called via a ninth API, and the communication module 432 may be called via a tenth API. In some embodiments, calls may also be made using event-based message interfaces in addition to APIs. An event-based message interface may be a design pattern that enables communication between services by defining events and handlers that process them. This approach may allow for efficient communication and decoupled components, which may lead to more flexible and modular systems.

In some embodiments, the process implemented by the ACLM 406 may be executed via the communication module 432, and the communication network 410, which may comprise plural networks as described above. In some embodiments, in an embodiment, the various components of the ACLM 406 may communicate with the server 404, and the database(s) 412 via the communication module 432 and the communication network 410 and the results may be displayed onto the GUI 434. Of course, these embodiments are merely exemplary and are not limiting or exhaustive. The database(s) 412 may include the databases included within the private cloud and/or public cloud and the server 404 may include one or more servers within the private cloud and the public cloud.

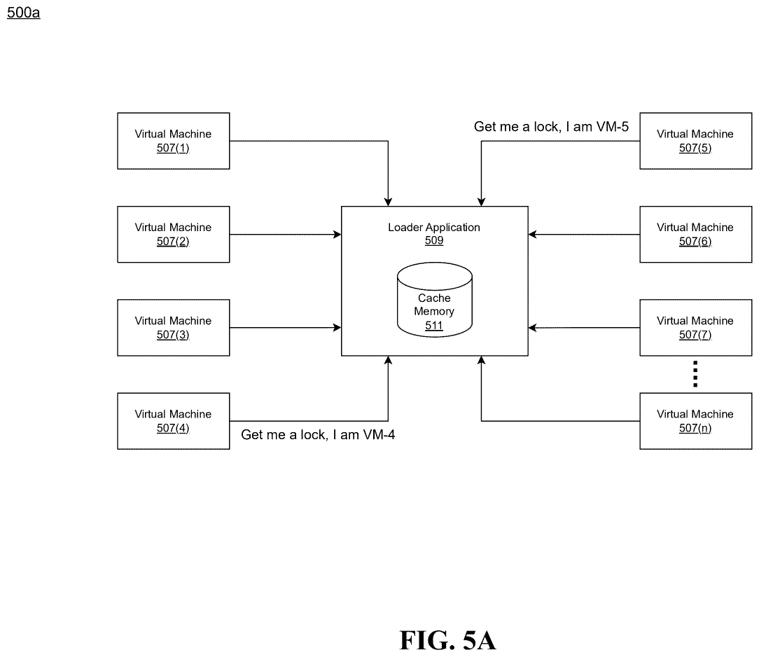

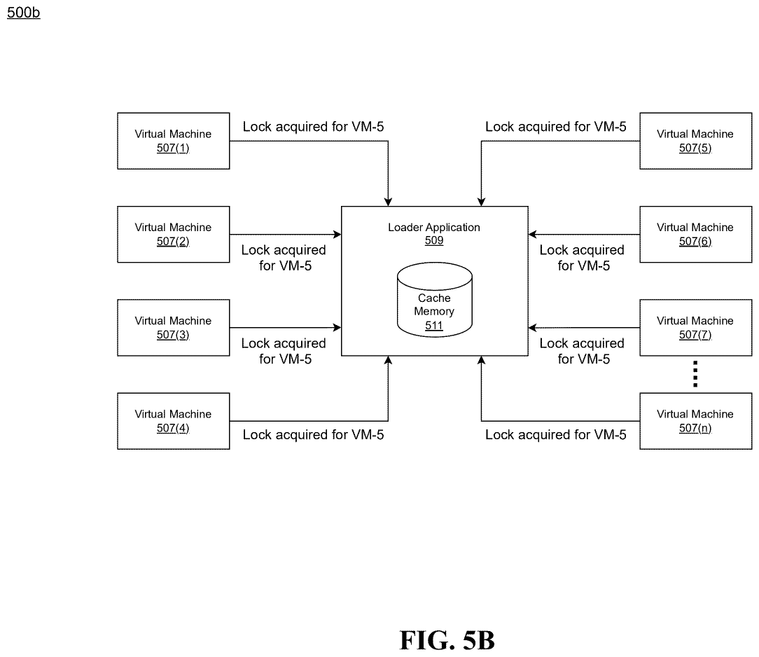

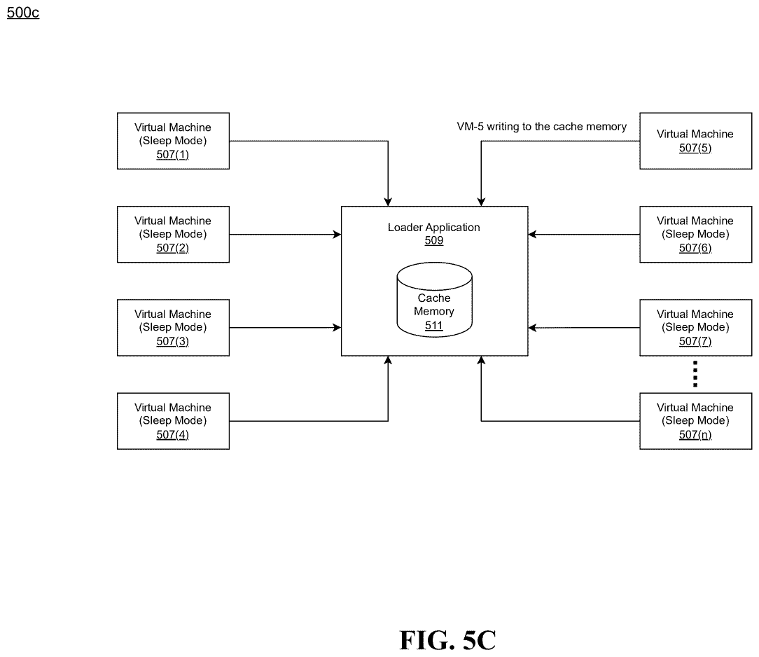

FIG. 5A illustrates an architecture 500a implemented by the platform, language, database, and cloud agnostic ACLM 406 of FIG. 4 for receiving ping from multiple virtual machines to obtain a lock in accordance with an embodiment. For example, FIG. 5A illustrates an architecture 500 implemented by the ACLM 406 of FIG. 4 for automatically locking a virtual machine to write data onto a cache memory when loading data from external distributed multi-cloud application environments that include the plurality of virtual machines 407 and the loader application 409 of FIG. 4 in accordance with an embodiment.

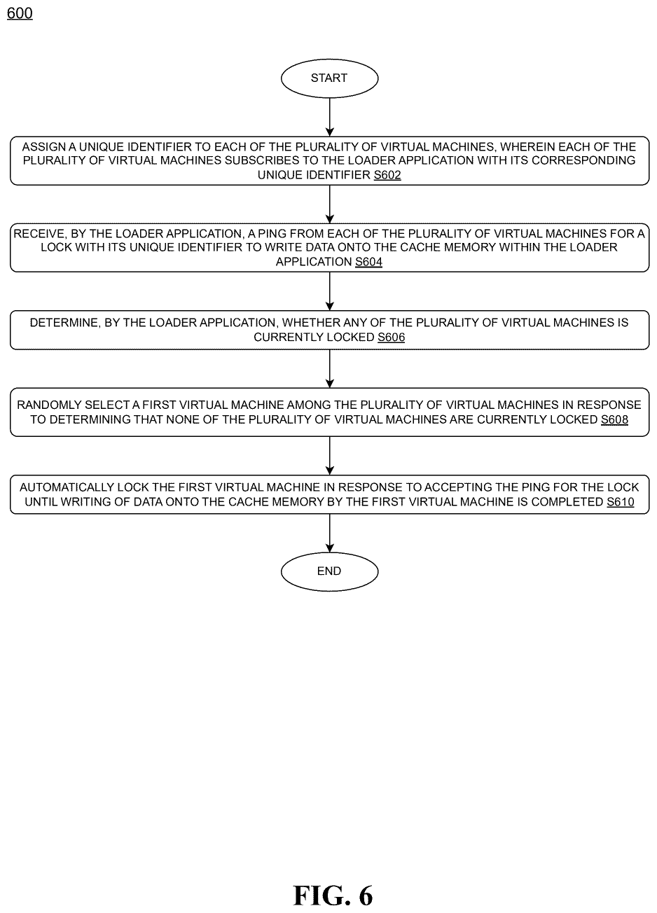

As illustrated in FIG. 5A, the plurality of virtual machines 507(1)-507(n) may be operatively connected to the loader application 509. The plurality of virtual machines 507(1)-507(n) and the loader application 509 as illustrated in FIG. 5 may be the same as the plurality of virtual machines 407 and the loader application 409, respectively, as illustrated in FIG. 4. The loader application 509 may include a cache memory 511 where each of the plurality of virtual machines 507(1)-507(n) may be allowed to write data or upload data onto the cache memory 511 when acquired a lock by the loader application 509 in consistent with a process 600 discussed herein with reference to FIG. 6.

The FIG. 6 illustrates a flow chart of the process 600 implemented by the ACLM 406 of FIG. 4 for automatically locking a virtual machine among the virtual machines 507(1)-507(n) to write data onto the cache memory 511 when loading data from the distributed multi-cloud applications discussed earlier in accordance with an embodiment. It may be appreciated that the illustrated process 600 and associated steps may be performed in a different order, with illustrated steps omitted, with additional steps added, or with a combination of reordered, combined, omitted, or additional steps.

Referring to FIGS. 4-6, in some embodiments, at step S602, the process 600 may include assigning, by calling the assigning module 414 (see FIG. 4) via a first API, assigning a unique identifier to each of the plurality of virtual machines 507(1)-507(n). Each of the plurality of virtual machines 507(1)-507(n) subscribes to the loader application 509 with its corresponding unique identifier. The assigning module 414 may implement any of the commonly used processes to assign a unique identifier to each of the plurality of virtual machines 507(1)-507(n), depending on the platform.

For example, for a cloud computing virtualization platform, the assigning module 414 may utilize the cloud computing virtualization platform's Web client to select a unique identifier option, such as the virtual machine's universal unique identifier (UUID) or Basic Input/Output System (BIOS) Globally Unique Identifier (GUID). A GUID is a unique reference number used to identify information on a computer or network, i.e., the plurality of virtual machines 507(1)-507(n). In some embodiments, the GUID may be used to identify each of the plurality of virtual machines 507(1)-507(n). BIOS is a program built into each of the plurality of virtual machines 507(1)-507(n). As one switches on the virtual machine, the program is operated. Typically, this program may be housed in ROM, and may be placed on the motherboard of the virtual machine. The BIOS GUID may be a 128-bit alphanumeric address that uniquely identifies each of the plurality of virtual machines 507(1)-507(n). For example, each of the virtual machine's UUID among the plurality of virtual machines 507(1)-507(n) may generated when the corresponding virtual machines is first powered on. The UUID may be stored in the system management BIOS system information descriptor and may be accessed by the assigning module 414 using the system management BIOS scanning program. If any of the plurality of virtual machines 507(1)-507(n) is moved or copied, it may receive a new UUID accordingly.

In some embodiments, at step S604, the process 600 may include receiving, by calling the receiving module 416 via the second API, by utilizing the loader application 509, a ping from each of the plurality of virtual machines 507(1)-507(n) for a lock with its unique identifier to write data onto the cache memory 511 within the loader application 509. For example, to receive a ping from a virtual machine successfully, the receiving module 416 may verify the virtual machine's network configuration in a guest operating system (not shown) and check for duplicate internet protocol (IP) addresses; check a firewall configuration associated with the virtual machine's network configuration to troubleshoot network connection issues; assign a floating IP address if the virtual machine has no public IP address; and ping a loopback address to verify that TCP/IP discussed above with reference to FIG. 2 is working correctly. A loopback address is an internal IP address that sends data packets back to a local system. Loopback addresses may be utilized to test communication channels without modifying or processing data. Loopback addresses may also be utilized to identify a device, a virtual machine discussed above, as the loopback address remains the same even if network topology changes.

As mentioned earlier, FIG. 5A illustrates an architecture 500a implemented by the platform, language, database, and cloud agnostic ACLM 406 of FIG. 4 for receiving ping from a plurality of virtual machines 507(1)-507(n) to obtain a lock in accordance with an embodiment. As illustrated in FIG. 5A, the loader application 509 may receive at step S604 a ping from the virtual machine 507(5) that may include that “get me a lock, I am a virtual machine identified via my UUID VM-5”. Concurrently, the loader application 509 may also receive at step S604 another ping from the virtual machine 507(4) that may include that “get me a lock, I am a virtual machine identified via my UUID VM-4”.

In some embodiments, at step S606, the process 600 implemented by the ACLM 406 of FIG. 4 may include determining by the loader application 509, by calling the determining module 418 via the third API, whether any of the plurality of virtual machines 507(1)-507(n) is currently locked. The term “lock” as disclosed herein may correspond to a process where only one virtual machine which obtains a lock from the loader application 509 among the plurality of virtual machines 507(1)-507(n) is allowed to write data onto the cache memory 511, and the remaining virtual machines go to a sleep mode, i.e., not allowed to write onto the cache memory 511 until the lock is released, and until each of the remaining virtual machines 507(1)-507(n) receives its corresponding lock. That is, with reference to FIGS. 5A and 6, at step S606, the process 600 implemented by the ACLM 406 of FIG. 4 may include determining by the loader application 509, by calling the determining module 418 via the third API, whether any of the virtual machines 507(4) and 507(5) is currently locked.

In some embodiments, at step S608, the process 600 implemented by the ACLM 406 of FIG. 4 may include, randomly selecting, by calling the selecting module 420 via the fourth API, a first virtual machine, i.e., virtual machine 507(5) in response to determining that none of the virtual machines 507(4) and 507(5) are currently locked (see FIG. 5A). In some embodiments, at step S610, the process 600 implemented by the ACLM 406 of FIG. 4 may include automatically locking, by calling the locking module 422 via the fifth API, the virtual machine 507(5), in response to accepting the ping for the lock until writing of data onto the cache memory 511 by the virtual machine 507(5) is completed.

In some embodiments, the process 600 implemented by the ACLM 406 may build a concurrency control mechanism for handling locking of the virtual machine 507(5) discussed above via utilization of a combination of design patterns including publish/subscribe design pattern, broad casting and gossip control among the virtual machines 507(1)-507(n) and resource locking using semaphores. For example, the locking module 422 may utilize semaphore algorithm to lock the virtual machine 507(5). A semaphore algorithm is a variable or abstract data type used to control access to a common resource by multiple threads and avoid critical section problems in a concurrent system such as a multitasking operating system, i.e., the loader application 509.

For example, as illustrated in FIG. 5A, the virtual machines 507(1)-507(n) may publish and subscribe to the loader application 509 by utilizing publish-and-subscribe (pub/sub) messaging pattern. The pub/sub messaging pattern is a messaging pattern that allows software components, i.e., virtual machines 507(1)-507(n), to communicate with each other asynchronously. In a pub/sub system, publishers send messages to a topic, i.e., the loader application 509, and subscribers receive messages from that topic. Most messaging systems support both the pub/sub and message queue models in their API, e.g., Java Message Service (JMS), but the disclosure is not limited thereto. This pattern provides greater network scalability and a more dynamic network topology, with a resulting decreased flexibility to modify the publisher and the structure of the published data.

By implementing the steps S602-S610 discussed earlier, the plurality of virtual machines 507(1)-507(n) may concurrently load external data into one common external cache, i.e., the cache memory 511 as illustrated in FIG. 5A that may be accessible for multiple read instances. All data should be loaded into cache memory 511 due to SLAs and no database hits for certain merchant information.

Upon locking the virtual machine 507(5) at step S608, the process 600 implemented by the ACLM 406 of FIG. 4 may include declining, by calling the declining module 426 via the seventh API, pings for additional lock from other virtual machines among the plurality of virtual machines 507(1)-507(n) except for the virtual machine 507(5) which has obtained the lock.

In some embodiments, at step S610, the process 600 implemented by the ACLM 406 of FIG. 4 may also include releasing the lock, by calling the lock releasing module 424 via the sixth API, when it is determined that the cache memory 511 is fully loaded upon completion of writing data by the first virtual machine, i.e., the virtual machine 507(5) which obtained the lock at step S608. The steps S602-S610 are repeated for next load cycle.

In some embodiments, the process 600 implemented by the ACLM 406 of FIG. 4 may further include: releasing the lock, by calling the lock releasing module 424 via the sixth API, when it is determined that the virtual machine 507(5) that has been randomly selected at step S608 is not writing data onto the cache memory 511 for a configurable predefined period of time, i.e., 2 minutes to 5 minutes, specifically 3 minutes, but the disclosure is not limited thereto; automatically locking, by calling the locking module 422 via the fifth API, a second virtual machine, i.e., virtual machine 507(4) among the plurality of virtual machines 507(1)-507(n), in response to accepting corresponding ping for a lock from the second virtual machine, i.e., virtual machine 507(4), until writing of data onto the cache memory 511 by the second virtual machine, i.e., virtual machine 507(4), is completed; and declining, by calling the declining module 426 via the seventh API, pings for additional lock from other virtual machines among the plurality of virtual machines 507(1)-507(n) except for the second virtual machine, i.e., virtual machine 507(4).

In some embodiments, the process 600 implemented by the ACLM 406 of FIG. 4 may further include: publishing a broadcast, by calling the publishing module 428 via the eighth API, by the loader application 507 to the plurality of virtual machines 507(1)-507(n), identity of the first virtual machine, i.e., virtual machine 507(5) in this example, that has acquired the lock via its unique identifier. For example, FIG. 5B illustrates an architecture 500b, implemented by the ACLM 406 of FIG. 4 for broadcasting to the plurality of virtual machines 507(1)-507(n) that a lock has been acquired for one of the plurality of virtual machines (in this example, virtual machine 507(5)) which requested a lock in FIG. 5A and was randomly selected by the selecting module 420 to receive the lock for writing onto the cache memory 411. As illustrated in FIG. 5B, the broadcast includes a message “lock acquired for virtual machine—5”.

In some embodiments, the process 600 implemented by the ACLM 406 of FIG. 4 may further include: causing each of the plurality of virtual machines 507(1)-507(n) to listen to the broadcast, i.e., “lock acquired for virtual machine—5”, discussed above; and validating, by calling the validating module 430 via the ninth API, corresponding unique identifier associated with each of the plurality of virtual machines with the unique identifier of the first virtual machine, i.e., virtual machine 507(5) that has acquired the lock.

In some embodiments, the process 600 implemented by the ACLM 406 of FIG. 4 may further include: determining, by calling the determining module 418 via the third API, that there is a match between a corresponding unique identifier associated with a second virtual machine with the unique identifier of the first virtual machine that has acquired the lock; determining that the second virtual machine is the same as the first virtual machine, i.e., virtual machine 507(5) because of the match of the unique identifiers; and allowing the second virtual machine (in this case the virtual machine 507(5)) to write data onto the cache memory 511.

In some embodiments, the process 600 implemented by the ACLM 406 of FIG. 4 may further include: determining, by calling the determining module 418 via the third API, that there is no match between a corresponding unique identifier associated with a second virtual machine with the unique identifier of the first virtual machine that has acquired the lock; determining that the second virtual machine is not the same as the first virtual machine because of mismatch of the unique identifiers; and blocking the second virtual machine to write data onto the cache memory 511 util the lock associated with the first virtual machine is released and until the second virtual machine acquires a lock.

For example, referring back to FIGS. 5A and 5B, both the virtual machine 507(5) (i.e., the first virtual machine) and the virtual machine 507(4) pinged the loader application 509 concurrently to obtain a lock and the virtual machine 507(5) has successfully obtained the lock. Thus, the ping request from virtual machine 507(4) is blocked/declined until the lock obtained by the virtual machine 507(5) is released. FIG. 5C illustrates an architecture 500c implemented by the ACLM 406 of FIG. 4 where the virtual machine, i.e., virtual machine 507(5) which obtained the lock in FIG. 5B is allowed to write onto the cache memory 511 and the remaining virtual machines, i.e., virtual machines 507(1)-507(4) and 507(6)-507(n) go to a sleeping mode,, i.e., not allowed to write onto the cache memory 511 until the lock is released, and until each of the remaining virtual machines 507(1)-507(4) and 507(6)-507(n) receives its corresponding lock, in accordance with an embodiment, thereby reducing data latency, increasing scale (wide distribution of data consumers), and reducing the utilization of compute resources (so these computer resources can be freed for devotion to other tasks), reducing memory consumption, reducing power consumption, increasing applications'performance, etc., but the disclosure is not limited thereto.

In some embodiments, the ACLD 402 may include a memory (e.g., a memory 106 as illustrated in FIG. 1) which may be a non-transitory computer readable medium that may be configured to store instructions for implementing a platform, language, database, and cloud agnostic ACLM 406 for automatically locking a virtual machine to write data onto a cache memory when loading data from distributed multi-cloud application environments that include a plurality of virtual machines, and a loader application as disclosed herein. The ACLD 402 may also include a medium reader (e.g., a medium reader 112 as illustrated in FIG. 1) which may be configured to read any one or more sets of instructions, e.g., software, from any of the memories described herein. The instructions, when executed by a processor embedded within the ACLM 406 or within the ACLD 402, may be used to perform one or more of the processes as described herein. In a particular embodiment, the instructions may reside completely, or at least partially, within the memory 106, the medium reader 112, and/or the processor 104 (see FIG. 1) during execution by the ACLD 402.

In some embodiments, the instructions, when executed, may cause a processor embedded within the ACLM 406 or the ACLD 402 to perform the following: assigning a unique identifier to each of the plurality of virtual machines, wherein each of the plurality of virtual machines subscribes to the loader application with its corresponding unique identifier; receiving, by the loader application, a ping from each of the plurality of virtual machines for a lock with its unique identifier to write data onto the cache memory within the loader application; determining, by the loader application, whether any of the plurality of virtual machines is currently locked; randomly selecting a first virtual machine among the plurality of virtual machines in response to determining that none of the plurality of virtual machines are currently locked; and automatically locking the first virtual machine in response to accepting the ping for the lock until writing of data onto the cache memory by the first virtual machine is completed, but the disclosure is not limited thereto. For example, the features values may represent other data as disclosed above. In some embodiments, the processor may be the same or similar to the processor 104 as illustrated in FIG. 1 or the processor embedded within the ACLD 202, ACLD 302, ACLD 402, and ACLM 406 which may be the same or similar to the processor 104.

In some embodiments, the instructions, when executed, may cause the processor 104 to further perform: releasing the lock when it is determined that the cache memory is fully loaded upon completion of writing data by the first virtual machine.

In some embodiments, the instructions, when executed, may cause the processor 104 to further perform: releasing the lock when it is determined that the first virtual machine that has been randomly selected is not writing data onto the cache memory for a configurable predefined period of time; automatically locking a second virtual machine among the plurality of virtual machines in response to accepting corresponding ping for a lock from the second virtual machine until writing of data onto the cache memory by the second virtual machine is completed; and declining pings for additional lock from other virtual machines among the plurality of virtual machines except for the second virtual machine.

In some embodiments, the instructions, when executed, may cause the processor 104 to further perform: declining pings for additional lock from other virtual machines among the plurality of virtual machines except for the first virtual machine.

In some embodiments, the instructions, when executed, may cause the processor 104 to further perform: publishing a broadcast, by the loader application to the plurality of virtual machines, identity of the first virtual machine that has acquired the lock via its unique identifier.

In some embodiments, the instructions, when executed, may cause the processor 104 to further perform: causing each of the plurality of virtual machines to listen to the broadcast; and validating corresponding unique identifier associated with each of the plurality of virtual machines with the unique identifier of the first virtual machine that has acquired the lock.

In some embodiments, the instructions, when executed, may cause the processor 104 to further perform: determining that there is a match between a corresponding unique identifier associated with a second virtual machine with the unique identifier of the first virtual machine that has acquired the lock; determining that the second virtual machine is the same as the first virtual machine because of the match of the unique identifiers; and allowing the second virtual machine to write data onto the cache memory.

In some embodiments, the instructions, when executed, may cause the processor 104 to further perform: determining that there is no match between a corresponding unique identifier associated with a second virtual machine with the unique identifier of the first virtual machine that has acquired the lock; determining that the second virtual machine is not the same as the first virtual machine because of mismatch of the unique identifiers; and blocking the second virtual machine to write data onto the cache memory util the lock associated with the first virtual machine is released and until the second virtual machine acquires a lock.

In some embodiments as disclosed above in FIGS. 1-6, technical improvements effected by the instant disclosure may include a platform for implementing a platform, language, database, and cloud agnostic automated cache locking module configured for automatically locking a virtual machine to write onto a cache memory when loading data from external distributed multi-cloud application environments, thereby reducing data latency, increasing scale (wide distribution of data consumers), and reducing the utilization of compute resources (so these computer resources can be freed for devotion to other tasks), increasing applications'performance, reducing memory consumption, reducing power consumption, etc., but the disclosure is not limited thereto.

Although the invention has been described with reference to several exemplary embodiments, it is understood that the words that have been used may be words of description and illustration, rather than words of limitation. Changes may be made within the purview of the appended claims, as presently stated and as amended, without departing from the scope and spirit of the present disclosure in its aspects. Although the invention has been described with reference to particular means, materials and embodiments, the invention is not intended to be limited to the particulars disclosed; rather the invention extends to all functionally equivalent structures, method, and uses such as are within the scope of the appended claims.

In some embodiments, while the computer-readable medium may be described as a single medium, the term “computer-readable medium” includes a single medium or multiple media, such as a centralized or distributed database, and/or associated caches and servers that store one or more sets of instructions. The term “computer-readable medium” shall also include any medium that may be capable of storing, encoding or carrying a set of instructions for execution by a processor or that cause a computer system to perform any one or more of the embodiments disclosed herein.

The computer-readable medium may comprise a non-transitory computer-readable medium or media and/or comprise a transitory computer-readable medium or media. In a particular non-limiting, exemplary embodiment, the computer-readable medium may include a solid-state memory such as a memory card or other package that houses one or more non-volatile read-only memories. Further, the computer-readable medium may be a random access memory or other volatile re-writable memory. Additionally, the computer-readable medium may include a magneto-optical or optical medium, such as a disk or tapes or other storage device to capture carrier wave signals such as a signal communicated over a transmission medium. Accordingly, the disclosure is considered to include any computer-readable medium or other equivalents and successor media, in which data or instructions may be stored.

Although the present application describes specific embodiments which may be implemented as computer programs or code segments in computer-readable media, it is to be understood that dedicated hardware implementations, such as application specific integrated circuits, programmable logic arrays and other hardware devices, may be constructed to implement one or more of the embodiments described herein. Applications that may include the various embodiments set forth herein may broadly include a variety of electronic and computer systems. Accordingly, the present application may encompass software, firmware, and hardware implementations, or combinations thereof. Nothing in the present application should be interpreted as being implemented or implementable solely with software and not hardware.

Although the present specification describes components and functions that may be implemented in particular embodiments with reference to particular standards and protocols, the disclosure is not limited to such standards and protocols. Such standards may be periodically superseded by faster or more efficient equivalents having essentially the same functions. Accordingly, replacement standards and protocols having the same or similar functions may be considered equivalents thereof.

The illustrations of the embodiments described herein are intended to provide a general understanding of the various embodiments. The illustrations are not intended to serve as a complete description of all of the elements and features of apparatus and systems that utilize the structures or method described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

One or more embodiments of the disclosure may be referred to herein, individually and/or collectively, by the term “invention” merely for convenience and without intending to voluntarily limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, may be apparent to those of skill in the art upon reviewing the description.

The Abstract of the Disclosure is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments require more features than are expressly recited in each claim. Rather, as the following claims reflect, inventive subject matter may be directed to less than all of the features of any of the disclosed embodiments. Thus, the following claims are incorporated into the Detailed Description, with each claim standing on its own as defining separately claimed subject matter.

The above disclosed subject matter is to be considered illustrative, and not restrictive, and the appended claims are intended to cover all such modifications, enhancements, and other embodiments which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

What is claimed is:

1. A method for automatically locking a virtual machine to write data onto a cache memory when loading data from distributed multi-cloud application environments that include a plurality of virtual machines and a loader application by utilizing one or more processors along with allocated memory, the method comprising:
assigning a unique identifier to each of the plurality of virtual machines, wherein each of the plurality of virtual machines subscribes to the loader application with its corresponding unique identifier;
receiving, by the loader application, a ping from each of the plurality of virtual machines for a lock with its unique identifier to write data onto the cache memory within the loader application;
determining, by the loader application, whether any of the plurality of virtual machines is currently locked;
randomly selecting a first virtual machine among the plurality of virtual machines in response to determining that none of the plurality of virtual machines are currently locked; and
automatically locking the first virtual machine in response to accepting the ping for the lock until writing of data onto the cache memory by the first virtual machine is completed.

2. The method of claim 1, further comprising:
releasing the lock when it is determined that the cache memory is fully loaded upon completion of writing data by the first virtual machine.

3. The method of claim 1, further comprising:
releasing the lock when it is determined that the first virtual machine that has been randomly selected is not writing data onto the cache memory for a configurable predefined period of time;
automatically locking a second virtual machine among the plurality of virtual machines in response to accepting corresponding ping for a lock from the second virtual machine until writing of data onto the cache memory by the second virtual machine is completed; and
declining pings for additional lock from other virtual machines among the plurality of virtual machines except for the second virtual machine.

4. The method of claim 1, further comprising:
declining pings for additional lock from other virtual machines among the plurality of virtual machines except for the first virtual machine.

5. The method of claim 1, further comprising:
publishing a broadcast, by the loader application to the plurality of virtual machines, identity of the first virtual machine that has acquired the lock via its unique identifier.

6. The method of claim 5, further comprising:
causing each of the plurality of virtual machines to listen to the broadcast; and
validating corresponding unique identifier associated with each of the plurality of virtual machines with the unique identifier of the first virtual machine that has acquired the lock.

7. The method of claim 6, further comprising:
determining that there is a match between a corresponding unique identifier associated with a second virtual machine with the unique identifier of the first virtual machine that has acquired the lock;
determining that the second virtual machine is the same as the first virtual machine because of the match of the unique identifiers; and
allowing the second virtual machine to write data onto the cache memory.

8. The method of claim 6, further comprising:
determining that there is no match between a corresponding unique identifier associated with a second virtual machine with the unique identifier of the first virtual machine that has acquired the lock;
determining that the second virtual machine is not the same as the first virtual machine because of mismatch of the unique identifiers; and
blocking the second virtual machine to write data onto the cache memory util the lock associated with the first virtual machine is released and until the second virtual machine acquires a lock.

9. A system for automatically locking a virtual machine to write data onto a cache memory when loading data from distributed multi-cloud application environments that include a plurality of virtual machines and a loader application, the system comprising:
a processor; and
a memory operatively connected to the processor via a communication interface, the memory storing computer readable instructions, when executed, causes the processor to:
assign a unique identifier to each of the plurality of virtual machines, wherein each of the plurality of virtual machines subscribes to the loader application with its corresponding unique identifier;
receive, by the loader application, a ping from each of the plurality of virtual machines for a lock with its unique identifier to write data onto the cache memory within the loader application;
determine, by the loader application, whether any of the plurality of virtual machines is currently locked;
randomly select a first virtual machine among the plurality of virtual machines in response to determining that none of the plurality of virtual machines are currently locked; and
automatically lock the first virtual machine in response to accepting the ping for the lock until writing of data onto the cache memory by the first virtual machine is completed.

10. The system of claim 9, wherein the processor is further configured to:
release the lock when it is determined that the cache memory is fully loaded upon completion of writing data by the first virtual machine.

11. The system of claim 9, wherein the processor is further configured to:
release the lock when it is determined that the first virtual machine that has been randomly selected is not writing data onto the cache memory for a configurable predefined period of time;
automatically lock a second virtual machine among the plurality of virtual machines in response to accepting corresponding ping for a lock from the second virtual machine until writing of data onto the cache memory by the second virtual machine is completed; and
decline pings for additional lock from other virtual machines among the plurality of virtual machines except for the second virtual machine.

12. The system of claim 9, wherein the processor is further configured to:
decline pings for additional lock from other virtual machines among the plurality of virtual machines except for the first virtual machine.

13. The system of claim 9, wherein the processor is further configured to:
publish a broadcast, by the loader application to the plurality of virtual machines, with identity of the first virtual machine that has acquired the lock via its unique identifier.

14. The system of claim 13, wherein the processor is further configured to:
cause each of the plurality of virtual machines listen to the broadcast; and
validate corresponding unique identifier associated with each of the plurality of virtual machines with the unique identifier of the first virtual machine that has acquired the lock.

15. The system of claim 14, wherein the processor is further configured to:
determine that there is a match between a corresponding unique identifier associated with a second virtual machine with the unique identifier of the first virtual machine that has acquired the lock;
determine that the second virtual machine is the same as the first virtual machine because of the match of the unique identifiers; and
allow the second virtual machine to write data onto the cache memory.

16. The system of claim 14, wherein the processor is further configured to:
determine that there is no match between a corresponding unique identifier associated with a second virtual machine with the unique identifier of the first virtual machine that has acquired the lock;
determine that the second virtual machine is not the same as the first virtual machine because of mismatch of the unique identifiers; and
block the second virtual machine to write data onto the cache memory util the lock associated with the first virtual machine is released and until the second virtual machine acquires a lock.

17. A non-transitory computer readable medium configured to store instructions for automatically locking a virtual machine to write data onto a cache memory when loading data from distributed multi-cloud application environments that include a plurality of virtual machines and a loader application, the instructions, when executed, cause a processor to perform the following:
assigning a unique identifier to each of the plurality of virtual machines, wherein each of the plurality of virtual machines subscribes to the loader application with its corresponding unique identifier;
receiving, by the loader application, a ping from each of the plurality of virtual machines for a lock with its unique identifier to write data onto the cache memory within the loader application;
determining, by the loader application, whether any of the plurality of virtual machines is currently locked;
randomly selecting a first virtual machine among the plurality of virtual machines in response to determining that none of the plurality of virtual machines are currently locked; and
automatically locking the first virtual machine in response to accepting the ping for the lock until writing of data onto the cache memory by the first virtual machine is completed.

18. The non-transitory computer readable medium of claim 17, wherein the instructions, when executed, cause the processor to further perform the following:
releasing the lock when it is determined that the cache memory is fully loaded upon completion of writing data by the first virtual machine.

19. The non-transitory computer readable medium of claim 17, wherein the instructions, when executed, cause the processor to further perform the following:
releasing the lock when it is determined that the first virtual machine that has been randomly selected is not writing data onto the cache memory for a configurable predefined period of time;
automatically locking a second virtual machine among the plurality of virtual machines in response to accepting corresponding ping for a lock from the second virtual machine until writing of data onto the cache memory by the second virtual machine is completed; and
declining pings for additional lock from other virtual machines among the plurality of virtual machines except for the second virtual machine.

20. The non-transitory computer readable medium of claim 17, wherein the instructions, when executed, cause the processor to further perform the following:
declining pings for additional lock from other virtual machines among the plurality of virtual machines except for the first virtual machine.
